(19) United States
(12) Patent Application Publication
(10) Pub. No.: US 2004/0218485 A1
(43) Pub. Date: Nov. 4, 2004

(54) Method and apparatus for disc protection during servo focusing

(76) Inventors: Jen-Yu Hsu, Taipei City (TW); Hsiang-Yi Fu, Taipei City (TW); Tun-Chieh Lee, Taipei City (TW); Fu-Hsiang Chen, Taipei City (TW); Yao-Chou Tsai, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/769,959

(22) Filed: Feb. 2, 2004

(30) Foreign Application Priority Data
Apr. 30, 2003 (TW) 92110129

(51) Int. Cl. G11B 7/095

(52) U.S. Cl. 369/44.27; 369/44.32; 369/53.28

(57) ABSTRACT

A method of disc protection during servo focusing is disclosed. First, the disc device performs a servo focusing on a disc at a first speed, and records the first focusing time accordingly. Afterward, the disc device calculates a second focusing time required for another servo focusing if the disc requires re-focusing, and re-focuses the disc if the second focusing time exceeds the first focusing time.

### BACKGROUND OF THE INVENTION

1. Field of the Invention

The present invention relates to a method and apparatus for disc protection, and particularly to a method and apparatus for disc protection that limits focusing time, thereby preventing the object lens of a disc device from contact with and damage to the disc during servo focusing.

2. Description of the Related Art

With the development of optical storage media, data can be recorded and backed up in high capacity, lighter discs. Moreover, disc devices such as CD-ROM drives are becoming essential equipment in computer systems and electronic multimedia devices.

Before the disc device reads data, an optical pickup head performs a servo focusing on the disc. The purpose thereof is to ensure the laser is accurately focused on the data recoding layer of the disc by controlling the movement of the object lens along the vertical orientation of the disc. The optical pickup head first uses a laser diode to direct laser beams onto a spectroscope via a raster. The spectroscope then redirects the laser beams to the object lens, and the object lens focuses the laser beams on the disc. After the reflection signal from the disc is received by the object lens and the spectroscope, a photo detector may analyze the reflected signal to obtain data from the disc.

FIG. 1 is a schematic diagram of an optical read system and a disc during servo focusing, in which 11 represents the trajectory of the optical read system. Since the distance between the data recording layer of the disc and the optical read system is dependent on the disc type, when a disc is loaded, servo focusing is performed, during which the optical read system first moves from a base position d1 to a predetermined position d2, and then moves toward the disc 10 to determine the distance to the data recording layer. After servo focusing, the optical read system can be adjusted to the appropriate position for optimal reading.

Conventional servo focusing is based on the FE (Focusing Error) signal, accomplished when the FE signal converges on a predetermined value. If disc imbalance occurs or the magnet core loses its magnetism, resulting in loss of focus at high rotation speeds, the disc device must repeat servo focusing. In addition, if the FE signal is not clear, the optical read system, such as the object lens, may gradually move close to the disc, causing damage thereto.

### SUMMARY OF THE INVENTION

It is therefore an object of the present invention to provide a method and apparatus for disc protection during servo focusing that prevents the object lens of a disc device from contacting and damaging the disc during servo focus.

To achieve the above object, the present invention provides a method of disc protection during servo focusing. First, the disc device performs a servo focusing on a disc at a first speed, and records the first focusing time accordingly. Next, the disc device calculates a second focusing time required for another servo focusing if the disc requires a re-focusing, and re-focuses the disc if the second focusing time exceeds the first focusing time.

Further, an apparatus for disc protection during servo focusing according to the present invention includes at least an optical read system and a process module. The optical read system performs a servo focusing on a disc at a first speed, and the process module records the first focusing time accordingly. If the optical read system performs another servo focusing, or a servo re-focusing, on the disc, the process module calculates a second focusing time required for the servo re-focusing and instructs the optical read system to re-focus the disc if the second focusing time exceeds the first focusing time.

If the optical read system cannot accomplish servo focusing or the servo re-focusing within a preset period or the number of trial times for servo re-focusing performed by the optical read system exceeds a preset value, the optical read system terminates disc focusing, and the process module issues an error message.

In addition, the first speed is the low access speed of the disc device.

### BRIEF DESCRIPTION OF THE DRAWINGS

The aforementioned objects, features and advantages of the invention will become apparent by referring to the following detailed description of the preferred embodiment with reference to the accompanying drawings, wherein:

FIG. 1 is a schematic diagram illustrating an optical read system and a disc during servo focusing;

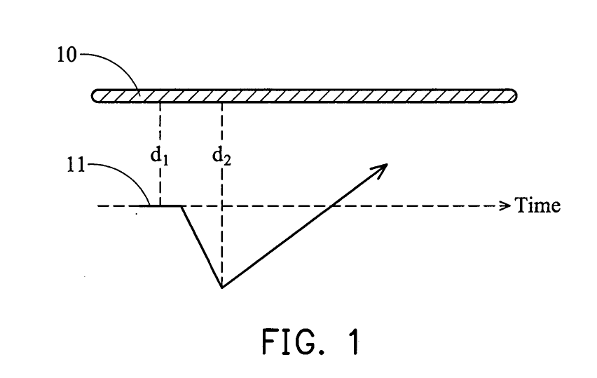

FIG. 2 is a schematic diagram illustrating the architecture of the apparatus for disc protection during servo focusing according to the present invention; and

FIG. 3 is a flowchart showing the method of disc protection during servo focusing according to the present invention.

### DETAILED DESCRIPTION OF THE INVENTION

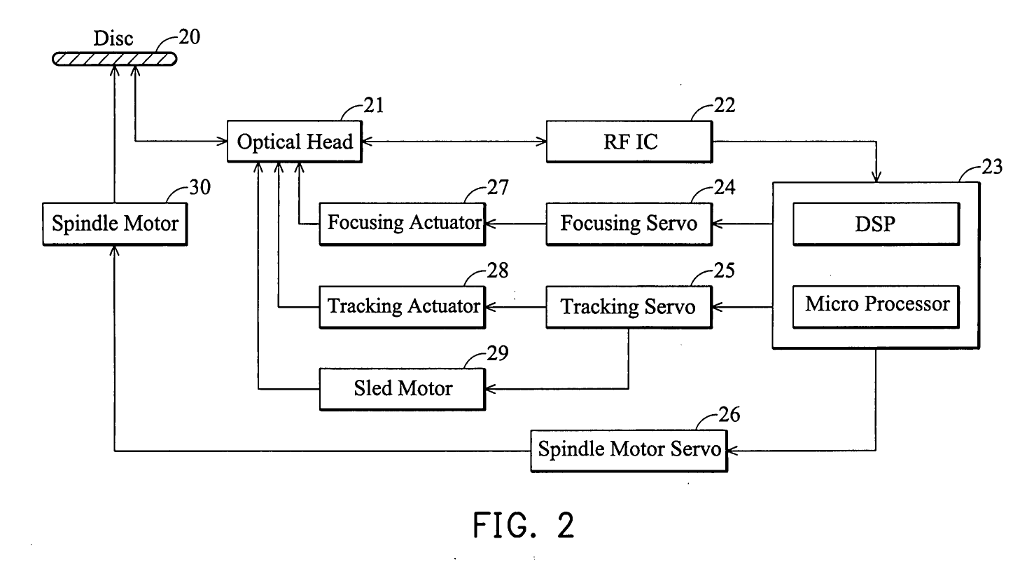

FIG. 2 illustrates the architecture of the apparatus for disc protection during servo focusing according to the present invention. In the embodiment, the apparatus may be a disc servo system, that is, the disc device may be applied in a CD-ROM drive, CD-RW drive, DVD-ROM drive, DVD-RW drive VCD player, or DVD player.

The optical pickup head (optical read system) 21 reads a reflection signal from the disc 20. After the signal is amplified and processed by RF (Radio Frequency) IC 22, the FE (FocusingError) signal, TE (TrackingError) signal and relative data and signals are input to the DSP (Digital Signal Processor) and micro processor (process module) 23.

After the micro processor 23 analyzes the received data and executed related operations, the disc type is identified, servo driver signals are computed, and the micro processor 23 outputs the signals to corresponding servos (focusing servo 24, tracking servo 25 and spindle motor servo 26) to control the actuators (focusing actuator 27, tracking actuator 28, sled motor 29 and spindle motor 30) to ensure accuracy when reading or writing data. The process of disc protection during servo focusing (focusing servo process) of the process module is described later.

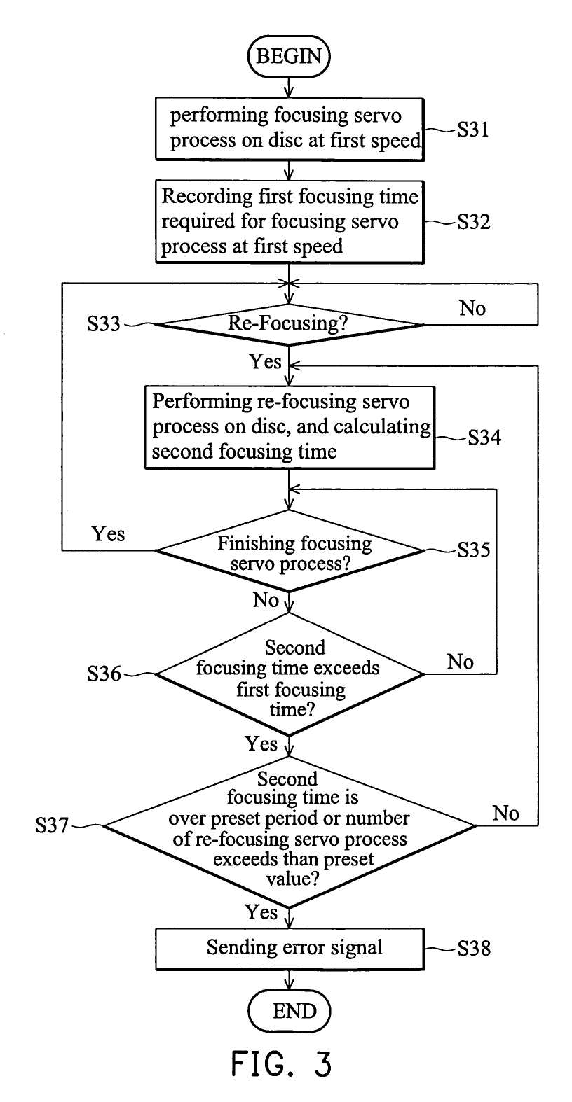

FIG. 3 shows the process of the method of disc protection during servo focusing according to the present invention. The embodiment of the present invention is suitable for use in disc devices such as CD-ROM drive, CD-RW drive, DVD-ROM drive, DVD-RW drive VCD player, or DVD player.

First, in step S31, the optical read system performs a servo focusing on a disc at a first speed, and in step S32, the process module records the first focusing time accordingly. The first speed is the low access speed of the disc device or the low access speed preset by the process module.

Afterward, in step S33, the process module determines whether the disc needs to be re-focused. It should be noted that if the disc device operates at the high rotation speed, disc imbalance may occur, or the magnet core may lose its magnetism resulting in loss of the focus, the disc device then must repeat servo focusing.

If the disc does not require re-focusing (No in step S33), the optical read system may continue to read data from the disc correctly, and the process module continues the determination in step S33. If the disc needs to be re-focused (Yes in step S33), in step S34, the optical read system performs another servo focusing (servo re-focusing/re-focusing servo process) on the disc, and the process module calculates a second focusing time required for the servo re-focus.

Thereafter, in step S35, the process module determines whether the servo re-focus is complete. If it's accomplished (Yes in step S35), the process module resets the second focusing time and the number of trial times for servo re-focusing performed by the optical read system, and the flow returns to step S33. Otherwise (No in step S35), in step S36, the process module determines whether the current second focusing time exceeds the first focusing time. If the current second focusing time does not exceed the first focusing time (No in step S36), the flow returns to step S35, the optical read system continues to focus on the disc, and the process module performs the determination in step S35.

Otherwise (Yes in step S36), in step S37, the process module determines whether the servo re-focusing has been accomplished within a preset period or the number of trial times for servo re-focusing performed by the optical read system exceeds a preset value. It should be noted that the purpose of step S37 is to prevent the disc device from expending undue resources on the servo re-focusing, thereby protecting the disc device. Further, the above preset period and preset value can be set according to the disc or disc device.

If the preset period does not pass or the number of trial times for servo re-focusing performed by the optical read system does not exceed a preset value (No in step S37), the flow returns to step S34, and the process module instructs the optical read system to re-focus the disc. It should be noted that the purpose of step S34 is to prevent erroneous determination of the FE signal, whereby the optical read system, such as the object lens, repeatedly approaches the disc, which may result in contacting and damaging the disc. Otherwise (Yes in step S37), in step S38, the process module issues an error message to a host for notifying users that servo focusing has failed.

As a result, using the method and apparatus for disc protection during servo focusing according to the present invention, the focusing time for every servo focusing is limited to less than that at the low access speed, thereby preventing the object lens of a disc device from contacting and damaging the disc during servo focus.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A method of disc protection during servo focusing, for use in a disc device, comprising the steps of:
performing a servo focusing on a disc at a first speed by the disc device;
recording a first focusing time required for servo focusing at the first speed; and
limiting a second focusing time required for a servo re-focusing to equal or less than the first focusing time if servo re-focusing is performed.

2. The method of disc protection during servo focusing as claimed in claim 1 further comprising instructing the disc device to perform another servo re-focusing if the second focusing time exceeds the first focusing time.

3. The method of disc protection during servo focusing as claimed in claim 2 further comprising terminating servo re-focusing if the servo re-focusing is not accomplished within a preset period.

4. The method of disc protection during servo focusing as claimed in claim 3 further comprising the disc device issuing an error message.

5. The method of disc protection during servo focusing as claimed in claim 2 further comprising terminating servo re-focusing if a number of trial times for servo re-focusing performed by the disc drive exceeds a preset value.

6. The method of disc protection during servo focusing as claimed in claim 5 further comprising the disc device issuing an error message.

7. The method of disc protection during servo focusing as claimed in claim 1 wherein the first speed is a low access speed of the disc device.

8. An apparatus for disc protection during servo focus, comprising:
an optical read system to perform servo focusing on a disc at a first speed; and
a process module to record a first focusing time required for servo focusing at the first speed, and limit a second focusing time required for a servo re-focusing to equal or less than the first focusing time if servo re-focusing is performed.

9. The apparatus for disc protection during servo focusing as claimed in claim 8 wherein the process module further instructs the optical read system to perform another servo re-focusing if the second focusing time exceeds the first focusing time.

10. The apparatus for disc protection during servo focusing as claimed in claim 9 wherein the process module further terminates servo re-focusing if the servo re-focusing is not accomplished within a preset period.

11. The apparatus for disc protection during servo focusing as claimed in claim 10 wherein the process module further issues an error message.

12. The apparatus for disc protection during servo focusing as claimed in claim 9 wherein the process module further terminates servo re-focusing if a number of trial times for servo re-focusing performed by the optical read system exceeds a preset value.

13. The apparatus for disc protection during servo focusing as claimed in claim 12 wherein the process module further issues an error message.

14. The apparatus for disc protection during servo focusing as claimed in claim 8 wherein the first speed is a low access speed preset by the process module.
